(19) United States
(12) Patent Application Publication
(10) Pub. No.: US 2026/0222178 A1
(43) Pub. Date: Jul. 30, 2026

(54) METHODS, DEVICES AND SYSTEMS FOR AUTHENTICATION OF WIRELESS DEVICES THAT CAN PRESERVE A SUPPLICANTS IDENTITY

(71) Applicant: Cypress Semiconductor Corporation, San Jose, CA (US)

(72) Inventor: Hui Luo, Marlboro, NJ (US)

(73) Assignee: Cypress Semiconductor Corporation, San Jose, CA (US)

(21) Appl. No.: 19/331,103

(22) Filed: Sep. 17, 2025

Related U.S. Application Data
(60) Provisional application No. 63/750,161, filed on Jan. 27, 2025.

(51) Int. Cl. H04L 9/08; H04L 9/32

(52) U.S. Cl. CPC H04L 9/0822; H04L 9/3263

(57) ABSTRACT

A method can include, by operation of a supplicant device, transmitting at least server identification data to an authenticator device over a wireless supplicant—authenticator connection. A tunnel connection can be established with an authentication server that includes messages relayed between the authentication server and the supplicant device by the authenticator device. An authentication operation can be executed with the authentication server over the tunnel connection using a PDC that remains encrypted with respect to the authenticator device. At least one encryption base value can be received from the authentication server via the tunnel connection. Authentication operation can be executed with the authenticator device using the at least one encryption base value over the supplicant—authenticator connection. A PDC can be essentially unique to the supplicant device. Corresponding devices and systems are also disclosed.

### CROSS-REFERENCE TO RELATED APPLICATIONS

The present application claims the priority and benefit of U.S. patent application Ser. No. 63/750,161 filed on Jan. 27, 2025, the contents of which are incorporated by reference herein in its entirety.

### TECHNICAL FIELD

The present disclosure relates generally to authentication operations in wireless systems, and more particularly to authentication in wireless systems with supplicant devices having per device identifiers.

### BACKGROUND

A per-device credential (PDC) can be a value specific to one wireless device. A PDC can have many applications, including providing for additional security and/or enabling differentiated access or services. Conventional Wi-Fi Protected Access 3 (WPA3) can include a personal mode in which a PDC can be used in a Simultaneous Authentication of Equals (SAE) operation. While such a conventional approach can protect a supplicant device's PDC against eavesdropping, such a PDC may be known or discernable by the authenticating device (e.g., access point, AP).

Another conventional approach can be W-Fi Enterprise mode based on Extensible Authentication Protocol with Transport Layer Security (EAP-TLS) v1.3. EAP-TLS v1.3 can protect a supplicant identity against eavesdropping, however a supplicant must typically include its own digital certificate, which can increase cost and complexity in deploying large numbers of supplicant devices.

It would be desirable to arrive at some way of authenticating a Supplicant with a PDC that can preserve privacy from an authenticator (e.g., AP), but not incur high costs and/or undue complexity that exists in conventional approaches.

### SUMMARY

A method can include, by operation of a supplicant device, transmitting at least server identification value to an authenticator device over a wireless connection. A tunnel connection can be established with an authentication server that includes messages relayed between the authentication server and the supplicant device by the authenticator device. An authentication operation can be executed with the authentication server over the tunnel connection using a per-device credential (PDC) that remains encrypted with respect to the relaying authenticator device. At least one encryption base value can be received from the authentication server via the tunnel connection. An authentication operation can then be executed with the authenticator device over an authenticator-supplicant connection different from the tunnel connection. Such an authentication operation can use the encryption base value provided by the authentication server. A PDC can be essentially unique to the supplicant device.

### BRIEF DESCRIPTION OF DRAWINGS

FIG. 1 is a signaling diagram showing a system and operations according to an embodiment.

FIGS. 2-0 and 2-1 are a signaling diagram showing a system and operations according to another embodiment.

FIGS. 3-0 and 3-1 are a flow diagram showing a method that can be executed by a supplicant device according to an embodiment.

FIG. 4 is a flow diagram showing a method that can be executed by an authenticator device according to another embodiment.

FIG. 5 is a flow diagram showing another method that can be executed by an authenticator device according to an embodiment.

FIG. 6 is a flow diagram showing a method that can be executed by an authentication server according to another embodiment.

FIG. 7 is a block diagram of an authenticator device according to an embodiment.

FIG. 8 is a block diagram of a supplicant device according to an embodiment.

FIG. 9 is a block diagram of an authentication server according to an embodiment.

FIG. 10 is a diagram of an integrated circuit device according to an embodiment.

FIG. 11 is a diagram of an automobile system according to an embodiment.

FIGS. 12-0 and 12-1 are diagrams of systems according to additional embodiments.

### DETAILED DESCRIPTION

According to embodiments, an authentication operation can include a supplicant device (Supplicant) authenticating with an authenticator device (Authenticator) by establishing a connection to an authentication server (Server) through messages relayed by the Authenticator. Such relayed messages can include encrypted data with respect to the Authenticator (i.e., a tunnel connection). A Supplicant can authenticate with the Server using a per-device credential (PDC) via the tunnel connection. Upon successful Supplicant-Server authentication, a Server can provide encryption base values (e.g., pairwise master key (PMK) or temporary secret) to a Supplicant via the tunnel connection. Corresponding encryption base values can be provided to the Authenticator through a secure Authenticator-Server connection. A Supplicant and Authenticator can then execute an authentication operation using the encryption base values separately provided by the Server. In this way, a Supplicant can authenticate with an Authenticator, while maintaining the privacy of its PDC.

In some embodiments, a Supplicant can transmit a request to an Authenticator that includes server information (S_ID) that identifies the corresponding Server (e.g., universal resource locator, intra-network address). An Authenticator can then connect to a Server using the S_ID. In some embodiments, an Authenticator can authenticate with a Server using a credential issued by the Server. In some embodiments, an Authenticator can maintain a list of supported Servers (e.g., supported S_IDs), and deny Supplicant requests that identify a non-supported Serer. In some embodiments, an Authenticator credential can include an authenticator id (ap_id), a password (pw_ap) and an S_ID.

In some embodiments, a Supplicant PDC can include three values: a Supplicant ID (sta_id), a password (pw_sta) and an S_ID. A sta_id and password can remain secret from an Authenticator (but provided to a Server through a tunnel connection). In some embodiments, a Authenticator can provide an admission set of that Supplicants it supports. If a Server receives an authentication request from a Supplicant not on the admission set, it can terminate the authentication operation. In addition or alternatively, a Supplicant PDC can include digital certificate issued by an entity controlling the Server.

In some embodiments, authentication between a Supplicant and Server via a tunnel connection can be according to any of: Extensible Authentication Protocol Tunneled Transport Layer Security (EAP-TTLS), Tunneled EAP (TEAP), or EAP-TLS v1.3.

In some embodiments, authentication between a Supplicant and Authenticator, using encryption base values separately provided by a Server, can include a four-way handshake (e.g., simultaneous authentication of equals, SAE).

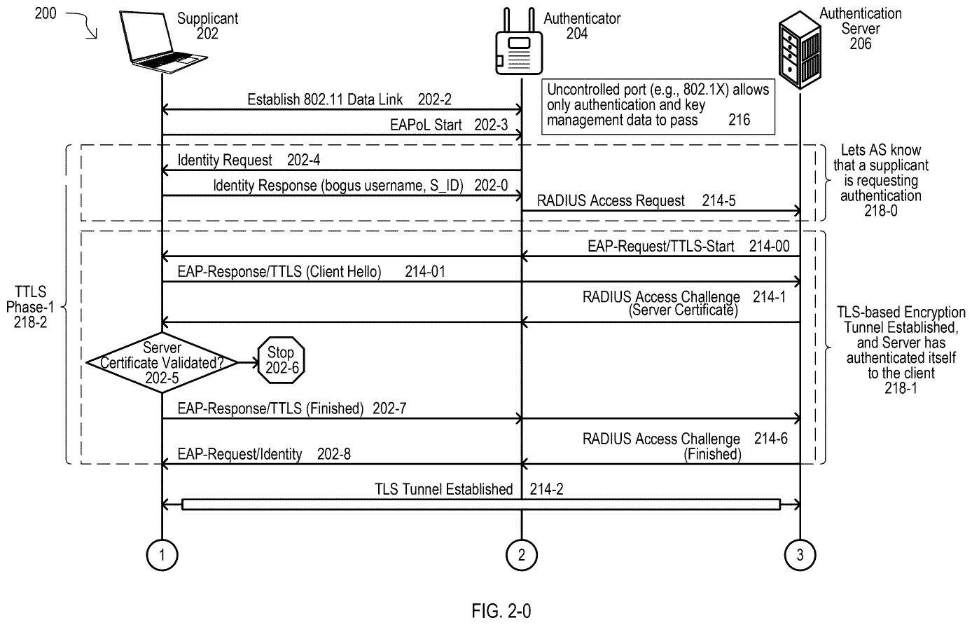

FIG. 1 is a signaling diagram shown a system 100 and operations according to an embodiment. A system 100 ca include a Supplicant 102, an Authenticator 104 and Server 106. A Supplicant 102 can store a PDC 108 that can be included in an authentication operation with Authenticator 104, but at the same time, remain secret from the Authenticator 104. In one or more messages, a Supplicant 102 can start an authentication operation with Authenticator 104 that includes a request 102-0. Such a request 102-0 can include an S_ID corresponding to Server 106.

Upon receiving request 102-0, Authenticator 104 can contact Server 106 using S_ID, and establish a secure Authenticator-Server connection 110-0. In some embodiments, a secure connection between Authenticator and Server may already be in place from other Supplicants seeking authentication.

Once a secure connection between Authenticator 104 and Server 106 has been established, an Authenticator 104 may begin relaying messages between a Server 106 and a requesting Supplicant 102. In the embodiment shown, such actions can include a Supplicant 102 and Server 106 establishing which ciphers/protocols can be used to create a tunnel connection 114-0. A Server 106 can provide a digital certificate 114-1 (relayed by Authenticator 104) for validation by Supplicant. In some embodiments, such an action can include a Supplicant 102 validating a server digital certificate using a known public key for the Server 106.

Once a Server 106 is validated by a Supplicant 102, using a cipher and protocol previously agreed upon, a Server 106 and Supplicant 102 can begin communicating with encrypted messages relayed by Authenticator 106 (i.e., a tunnel connection can be established) 114-2

Over a tunnel connection, a Server 106 can authenticate a Supplicant 102 using the Supplicant's PDC 108. If such Server-Supplicant authentication is successful, a Server 106 can transmit one or more encryption base values to Supplicant 102 over the tunnel connection 120. It is understood that such encryption base values are for a Supplicant 102 to authenticate with Authenticator 104.

Over a separate secure Authenticator-Server connection, a Server 106 can transmit one or more encryption base values 110-1 to Authenticator 106. It is understood that such encryption base values are for a Supplicant to authenticate with Authenticator 104.

Once a Supplicant 102 and Authenticator 104 have been separately provided with encryption base values over different connections, a Server 106 can terminate a tunnel connection 114-4.

A Supplicant 102 and Authenticator 104 can then execute an authentication operation 122 using encryption base values provided by a Server.

In this way, a Supplicant can authenticate with an Authenticator by contacting a Server, which can separately provide encryption base values to the Supplicant and Authenticator, where the encryption base values are derived with a personal ID value (e.g., PDC) of the Supplicant kept secret from the Authenticator.

In some embodiments, a system can be based on a Supplicant and Authenticator operating according to one or more IEEE 802.11 wireless standards. In such embodiments, a Supplicant can be a station device (STA) and an authenticator can be an access point (AP). An AP can be capable of communicating with a Server(S) in any suitable fashion, including but not limited to, a private network or public network including via the Internet.

According to embodiments, an AP-to-STA authentication can be carried out by an AP-to-S mutual authentication and a S-to-STA authentication via a STA-S TLS tunnel. A STA-S TLS tunnel can include messages relayed by an AP. AP-to-S mutual authentication can be attempted using an AP's credential issued by the S. AP-to-S mutual authentication can create a secure AP-S connection for the purpose of relaying messages in a STA-S TLS tunnel. If AP-to-S mutual authentication fails, a secure AP-S connection cannot be established, preventing the AP from relaying messages in an STA-S TLS tunnel. As a result, a STA attempt to authenticate with an AP can time out, and the STA can abort the connection with the AP.

If AP-to-S mutual authentication succeeds, a STA can verify S's certificate during the setup of a STA-S TLS tunnel with the AP relaying the messages between the STA and S. In some embodiments, such messages can be EAP-type messages.

STA-to-AP authentication can be carried out by an STA-to-S authentication inside the STA-S TLS tunnel after a successful AP-to-S authentication. In some embodiments, after verifying a STA's PDC, a S can also determine if a STA_ID of the STA is in an Admission_Set for the AP. An Admission_Set can list one or more STA_IDs with which an AP can authenticate. Upon successful authentication with a STA, S can send the authentication result and a PMK or a temporal secret to the STA over the STA-S TLS tunnel and to the AP over the AP-S secure connection. The S can then terminate the STA-S TLS tunnel.

STA-to-AP authentication can then conclude with a mutual authentication over a STA-AP connection using the PMK or temporal secret separately provided by the S.

According to some embodiments, a system can include a STA that uses a PDC, an AP (or a multi-AP network), a PDC server S. In some embodiments, S can be an issuer of PDCs and an authenticator (via a tunnel connection) using PDC.

A PDC can take any suitable form. In some embodiments, a PDC can include a triplet of a STA_ID, password, and S's URL or equivalent value for usability. Alternatively, a PDC can include a client digital certificate signed by S. In some embodiments, a S can have one or more key pairs, each including a public encryption key (Ps) and private encryption key (ps). Ps is signed in a certificate issued by a certificate authority (CA) accessible by a STA, or can be known by a STA from a PDC issued by S (which can be a client certificate PDC in some embodiments).

It is understood that a STA can have multiple PDCs issued by different PDC servers. It is also understood that an AP (or a multi-AP network) can support STAs with PDCs issued by different PDC servers. Thus, an AP (or multi-AP network) can be in communication with multiple different PDC servers.

If an AP (or a multi-AP network) agrees to support STAs with PDCs issued by an S, the AP (or a multi-AP network) and S can mutually authenticate with each other using a credential issued by S to the AP when the agreement is set up. The AP's credential could take any suitable form, including a triplet (ap_id, password, S's URL or equivalence), or a client certificate signed by S.

In some embodiments, an AP can specify an Admission_Set (e.g., {sta_id1, sta_id2, . . . }) which can be sent to S. Upon receiving an Admission_Set, an S can admit only those STAs with a sta_id in the AP's Admission_Set. In some embodiments, a sta_id can contain wild-card characters (i.e., able to match against multiple different STAs). A sta_id can also be included in a STA's client certificate.

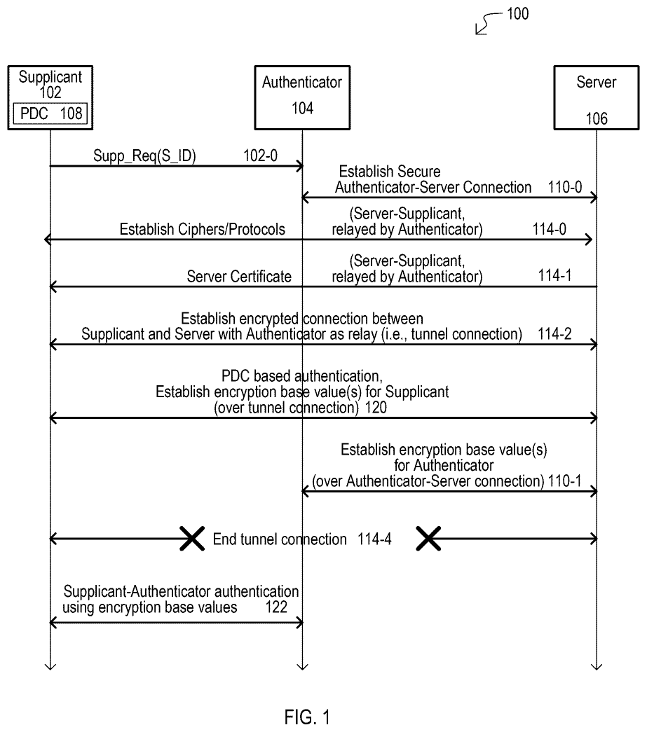

FIGS. 2-0 and 2-1 are signaling diagrams of a system 200 and operations according to another embodiment. A system 200 can be one implementation of that shown in FIG. 1. A system 200 can include a Supplicant 202, which can be a STA, an Authenticator 204, can be an AP, and an Authentication Server (Server) 206. In some embodiments, a system 200 can operate according to an IEEE 802.1X port-based access protocol, in which Authenticator 204 can include an uncontrolled port and a controlled port. Initial communications and relayed communications (i.e., tunnel connection) can occur via an uncontrolled port 216. Once a Supplicant has been adequately authenticated with an Authenticator, communications can occur via a controlled port 226.

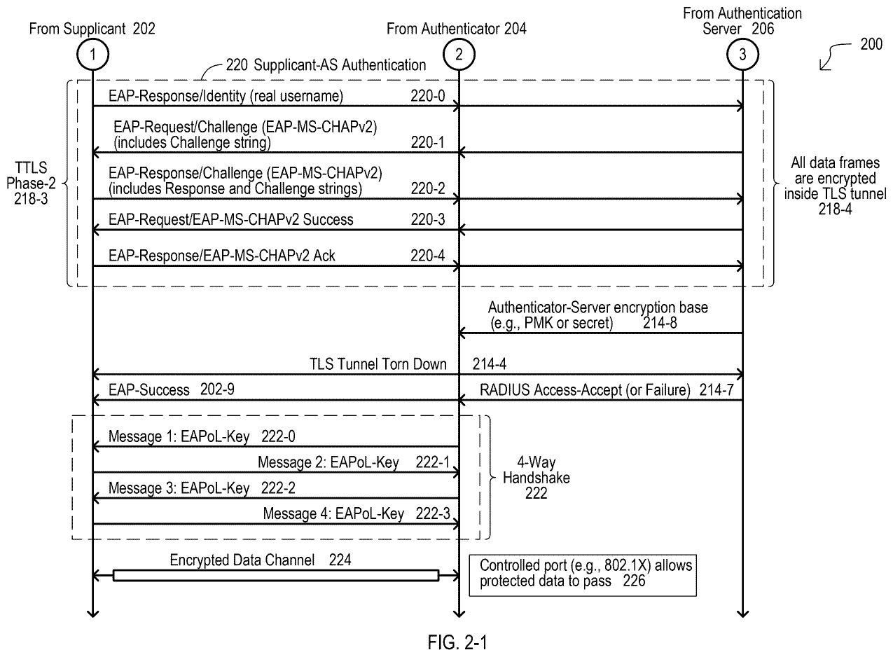

Operations of a system 200 can include a TTLS phase-1 218-2 (shown in FIG. 2-0) and a TTLS phase-2 (shown in FIG. 2-1). In a TTLS phase-1 218-2, an Authenticator 204 can authenticate with Server 206. In addition, a Supplicant 202 can request authentication from Server 206 via Authenticator 218-0, and then establish a tunnel connection with a Server 206. In a resulting tunnel connection, messages can be relayed by, but encrypted with respect to, Authenticator 204 (i.e., Authenticator is not in possession of a corresponding decryption key). In a TTLS phase-2 218-3 (shown in FIG. 2-1), a Supplicant 202 can be authenticated with Server 206 via the tunnel connection established through Authenticator 206.

Referring now to FIG. 2-0, operations of system 200 can include a Supplicant 202 establishing an initial data link 202-2 with an Authenticator 204. Over such a link, a Supplicant 202 can then transmit an EAPoL Start frame 202-3 to initiate an authentication process. In response, Authenticator 204 can transmit an identity request 202-4 to Supplicant 202. A Supplicant 102 can return an identity response 202-0. According to embodiments, an identity response can include an S_ID, however, to preserve a Supplicant's identity, an identity value provided is not a Supplicant's true identity (e.g., a bogus username). Further, if a Supplicant is in possession of multiple PDCs corresponding to different PDC issuers, a Supplicant can select one PDC, or a subset of such PDCs, based on any suitable condition, including but not limited to the operating environment (e.g., SSID of Authenticator), an application being executed by a Supplicant, application data generated by a Supplicant, or geolocation of a Supplicant, etc. If an Authenticator 204 does not support a Server identified by a S_ID, the Authenticator 204 can send a EAP-Failure message to a Supplicant 202.

If an Authenticator can support an indicated S_ID, an Authenticator 204 can transmit an access request 214-5 to a Server 206. In some embodiments, such a request can be according to a Remote Authentication Dial-In User Service (RADIUS) protocol. In some embodiments, an access request 214-5 can include information that can enable an Authenticator 204 to be validated by Server 206. Messages 202-4, 202-0 and 214-5 can indicate that a Supplicant is requesting authentication 218-0.

In response to an access request 214-5, a Server 206 can transmit a TTLS-Start message 214-00, relayed by an Authenticator 204 as an EAP-Request, which can indicate to a Supplicant 202 that a Server 206 is seeking to establish a tunnel connection. In some embodiments, such a message 214-00 (or another message from Server 206 to Authenticator 204) can enable Authenticator 204 to validate a Server 206.

Supplicant 202 can transmit an EAP-Response that can include a TTLS Client Hello message 214-01 which can be relayed to Server 206 by Authenticator 204. In some embodiments, such a message can include information that can indicate a type of tunnel connection that can be supported (e.g., supported cipher suites, protocols). In addition, a Client Hello message 214-01 can include a challenge value (e.g., random number) for encryption by the Server 206 with its private key (ps).

A Server 206 can return a Server Certificate message 214-1 (relayed by Authenticator 204). In some embodiments, such a message can include an agreed upon encryption/protocol for a tunnel connection. In some embodiments, Server Certificate message 214-1 can include a result of operations on the challenge value from the Supplicant with a private key (ps).

Upon receiving Server Certificate message 214-1, Supplicant 202 can verify a Server Certificate is valid 202-5. In some embodiments, such an action can include using a Server public key (Ps) that is already in possession of the Supplicant, or that can be accessed as part of a public-private key infrastructure. In some embodiments, a Supplicant 602 may also validate a challenge value sent in a previous message (e.g., Client Hello). If a Supplicant 202 cannot validate a Server 206 (N from 202-5), the protocol can be aborted 202-6.

If a Supplicant 202 validates a Server 206 (Y from 202-5), the Supplicant can transmit a EAP-Response (relayed by Authenticator 204) indicating that TTLS setup is finished 202-7. A Server 206 can return an access challenge message indicating that an access challenge has been finished 214-6. In a same or different message, a Server 206 can make an identity request to the Supplicant 202 as an EAP-Request 202-8. A TLS tunnel can thus be established 214-2.

Referring now to FIG. 2-1, operations can continue at connection circles 1, 2 and 3, also shown in FIG. 2-0. A Supplicant 202 can authenticate itself to the Server 206 via messages transmitted through a tunnel connection 220. In the embodiment shown, a Supplicant 202 can transmit an EAP-Response, which can include an encrypted identity response for the Server 220-0. It is noted that, unlike the initial identity response 202-0 of FIG. 2-0, a Supplicant 202 can provide its true username in the identity response, as it is encrypted and thus private from Authenticator 204 as well as eavesdroppers. In some embodiments, such a username can be a sta_id.

In the embodiment shown, authentication to a Server 206 via a tunnel connection can include a Challenge Handshake Authentication Protocol (CHAP) that does not transmit a password. However, embodiments anticipate any other suitable authentication protocols, including those that can transmit a password, such as a Password Authentication Protocol, as but one example.

Referring still to FIG. 2-1, Server 206 can transmit an authentication challenge 220-1 to Supplicant 202, which can be received as an EAP-Request. The particular challenge shown can be compatible with Microsoft CHAP version 2 (MS-CHAPv2). Such a challenge can include a challenge string that can be operated on using a secret value (e.g., password) known to both the Supplicant 202 and the Server 206.

A Supplicant 202 can transmit a challenge response as an EAP-Response 220-2 to Server 206 via tunnel connection. In some embodiments, such a challenge response can include a response string. In some embodiments, a response string can be the challenge string after it has been operated on (e.g., hash, encryption) by a function using a password.

Server 206 can evaluate a challenge response. If the challenge response is valid, and optionally, if the Supplicant 202 is on an admission set provided by Authenticator, Supplicant-Server authentication can be successful. Server 206 can transmit an authentication success message 220-3, which can be received by a Supplicant as an EAP-Request. In a same or different message, a Server 206 can send one or more encryption base values (e.g., a PMK or temporal secret) to a Supplicant 202. In some embodiments, such encryption base values can be generated using a PDC or values corresponding to a PDC. The same, or corresponding encryption base values can be provided to Authenticator 204 in a message 214-8 transmitted over a secure Authenticator-Server connection.

Supplicant 202 can provide an acknowledgement 220-4 transmitted as a EAP-Response. This can complete TTLS Phase-2 218-2, with Supplicant-Server authentication being successful. Though not shown in FIG. 2-1, if Supplicant-Server authentication fails, a failure message can be transmitted. It is understood that authentication messages 220-0, 220-1, 220-2, 220-3, 220-4 are all encrypted inside a TLS tunnel 218-4 and so private from Authenticator 204. After Supplicant-Server authentication has been attempted (and succeeded or failed) via a tunnel connection, the tunnel connection can be torn down 214-4.

Server 206 can transmit an authentication result message 214-7 that can indicate a result of an authentication attempt by Supplicant 202. In some embodiments, such a message can be in the form of a RADIUS acceptance failure (or rejection). Such a message can be relayed to a Supplicant 202 as an EAP-Success (or failure) message 202-9. Further, in some embodiments, such a message can include encryption base values for Authenticator 204 (i.e., take the place of message 214-8).

In the event of a successful authentication of Supplicant 202 by Server 206, a Supplicant 202 and Authenticator 202 can be in possession of encryption base values provided separately from Server 206. Supplicant 202 and Authenticator 204 can then execute a mutual authentication operation using their received encryption base values. Authentication can proceed according to any suitable protocol, and in the embodiment shown, can include a four-way handshake 222 between Supplicant 202 and Authenticator 204 using EAPoL key messages 222-0, 222-1, 222-2 and 222-3 (e.g., SAE). Once Supplicant 202 and Server 204 are authenticated with one another, communications between the two devices can occur over an encrypted data channel 224. In the embodiment shown, this can be a controlled port according to IEEE 802.1X 226.

In this way, a Supplicant having a secret value (e.g., identity) seeking authentication with an Authenticator can identify a Server. The Authenticator can communicate with the Server and establish a tunnel connection between the Supplicant and Server. Using the tunnel connection, a Supplicant can authenticate with the Server using its secret value which remains hidden from the relaying Authenticator. A Server can then provide encryption base values to the Supplicant over the tunnel connection and to the Authenticator over a different, secure connection. An authentication operation can then proceed between the Supplicant and Authenticator using the encryption base values.

Having described systems and corresponding operations and methods, additional methods executable by various devices will now be described with reference to flow diagrams.

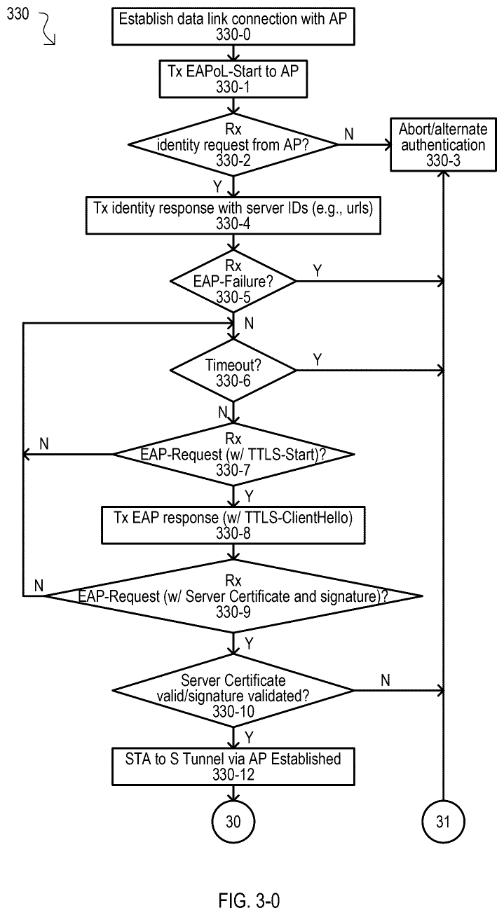

FIGS. 3-0 and 3-1 show a flow diagram of a method 330 according to an embodiment. A method 330 can include actions, all or a portion of which can be executed by a STA (i.e., Supplicant) as described herein and equivalents. Referring to FIG. 3-0, a method 330 can establish a data link connection with an AP (i.e., Authenticator) 330-0. Such an action can include any suitable wireless connections, and in some embodiments can include communications according to one or more IEEE 802.11 wireless standards. In some embodiments, such an action can include connecting to an uncontrolled port compatible with an IEEE 802.1X standard.

A method 330 can include transmitting an EAPoL start data frame to an AP 330-1. If an identity request is not received from the AP (N from 330-2), the authentication process can end and/or an alternative authentication process can be pursued 330-3 (e.g., personal mode). If such an identity request is received (Y from 330-2), an identity response can be transmitted that includes one or more S_IDs (e.g., URLs) 330-4. Such an identity response may not provide accurate information identifying a Supplicant (e.g., a bogus username). If a EAP-Failure message is received (Y from 330-5) or a timeout period has been exceeded (Y from 330-6), an authentication process can end or alternative pursued 330-3.

If a time out period is not exceeded (N from 330-6) and an EAP-Request is received with a tunnel start message (e.g., TTLS-Start) (Y from 330-7), a method 330 can transmit an EAP-Response with data for establishing a tunnel connection (e.g., TTLS-ClientHello) 330-8. If an EAP-Request is received with a Server certificate (Y from 330-9), an attempt can be made to validate the Server certificate 330-10. If a Server certificate is not received (N from 330-9) or is determined not to be valid (N from 330-10), an authentication operation can be aborted or alternative sought (330-3).

If a server certificate is valid (Y from 330-12), a STA to S tunnel connection via an AP can be established 330-12.

Referring to FIG. 3-1, a method 330 can continue at connection circles 30 and 31, also shown in FIG. 3-0. A determination can be made as to whether a EAP-Request has been received that includes an encrypted request from a Server via a tunnel connection 330-13. If such a request is not received (N from 330-13), an authentication operation can be aborted or an alternative sought 330-3. If such a request is received (Y from 330-13), an EAP-Response can be transmitted that includes an encrypted identity message 330-14. Such an identity message can identify the STA (e.g., include a true username).

In-tunnel Authentication operations can then be executed with a Server 330-15. Such an authentication operation can take any suitable form, including but not limited to, EAP-TTLS/PAP or EAP-TTLS/MSCHAPv2. If an EAP-Request is not received with an encrypted authentication request and encryption base from a tunnel (N from 330-16), an authentication operation can be aborted or an alternative sought 330-3. In some embodiments, such a message, or another in-tunnel message, can include encryption base values for a follow-on authentication operation with an AP. In the embodiment shown, a EAP-Response with an encrypted acknowledgment the authentication success can be transmitted 330-17.

If an EAP-Success message is not received from a Server (N from 330-18), an authentication operation can be aborted or an alternative sought 330-3. If such a success message is received (Y from 330-10), an authentication protocol can be executed with an AP using encryption base values. Such an authentication protocol can occur over an AP-STA connection (i.e., not in-tunnel messaging) 330-19.

In this way, a method can include responding to an identity request from an AP with Server identification data. A Server digital certificate can be received and validated to establish a STA-Server tunnel connection. A STA can authenticate with a Server over a tunnel connection and receive encryption base values for authenticating with an AP over an AP-STA connection different from the STA-Server tunnel connection.

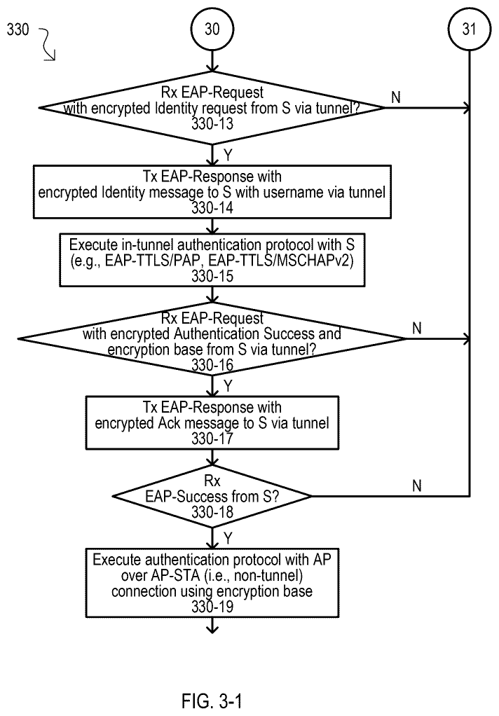

FIG. 4 is a flow diagram of a method 432 according to another embodiment. A method 432 can include actions, all or a portion of which can be executed by an AP (i.e., Authenticator). A method 432 can include establishing a data link connection with a STA (i.e., Supplicant). If an EAPoL start message is not received from a STA (N from 432-1), communications with a STA can end 432-2. If such a message is received (Y from 432-1), an identity request can be transmitted to a STA 432-3.

If an identity response that includes a Server ID is not received (N from 432-4), a method 432 can end communications with a STA 432-2. If such a response is received (Y from 432-4), a method 432 can determine if an identified Server is supported (e.g., if it has an appropriate security credential for the Server) 432-5. If a Server is not supported (N from 432-5), a method 432 can transmit an EAP-Failure message to a STA 432-6, and communications with a STA can end 432-2.

If an AP supports a Server (Y from 432-5), an access request can be transmitted to a Server 432-7. In some embodiments, such an action can include transmitting a signed digital certificate or other credential that would be known to a supported Server. Messages can then be relayed between a STA and Server 432-8. Such an action can include an Authenticator acting as a relaying device to enable a STA and Server to establish a tunnel connection as described herein and equivalents. If encryption base values are not received from a Server (N from 432-9), a method 432 can end communications with a STA.

If encryption base values are received from a Server (Y from 432-9), authentication between a STA and Server, using a STA's secret or private values can have been successful, and an authentication protocol can be executed with a STA. Such authentication can occur over a AP-STA (non-tunnel) connection 432-10.

In this way, a method can include receiving an authentication start and Server identification value from a STA, determining if the identified Server is supported. If the Server is supported, it can be contacted, messages can be relayed between the Server and STA. Encryption base values can be received from a Server and used for an authentication operation with the STA.

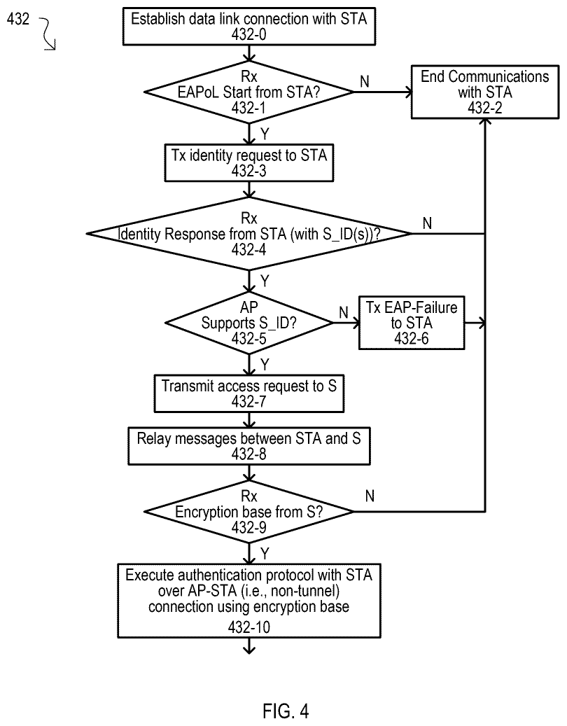

In some embodiments, an AP can support multiple modes of authenticating with a STA, including a Personal mode, in which a STA can provide identification data, as well as by using a tunneled connection with a Server, as described herein and equivalents. A method according to such an embodiment is shown in FIG. 5.

FIG. 5 is a flow diagram of a method 532 according to another embodiment. A method 532 can include actions, all or a portion of which can be executed by an AP. A method 532 can include establishing a data link connection with a STA 532-20. A personal mode authentication method can be started 532-21. Such an action can include transmitting a message to a STA indicating an authentication method or protocol that can request or receive an identification value of the STA. If such a personal mode authentication is successful (Y from 532-22), a method 532 can communicate with STA over a resulting secure connection 532-26.

If a personal mode authentication is not successful (N from 532-22) (e.g., a STA has rejected Personal mode), a method can attempt an EAP over tunneled TLS authentication 532-23, as described herein or an equivalent. Such an EAP over tunneled TLS authentication may keep a STA identification secret from a relaying AP. If such a tunneled authentication is not successful (N from 532-24), a method 532 can end a connection 532-25. If such authentication is successful (Y from 532-24), a method 532 can communicate with STA over a resulting secure connection 532-26.

In this way, when contacted by a Supplicant, an Authenticator can attempt an authentication method that can reveal a Supplicant's identity. If such an attempt is rejected, the Authenticator can attempt a Supplicant—Server tunneled authentication that hides a Supplicant identity from the Authenticator.

According to embodiments, the ability to support in-tunnel authentication to protect a STA identity from an AP can be indicated by one or more information elements (IEs) present in AP communications (e.g., beacons, probe responses, identity requests). If a STA does not understand an IE or new fields defined in an existing IE indicating in-tunnel authentication capabilities provided from an AP, a STA can connect to an AP using other established authentication techniques (e.g., WPA2-PSK or WPA3-SAE).

If an STA and an AP support a protected SAE password identifier method, and a STA has an identifier and password as a PDC, the STA can connect to the AP using a protected SAE password identifier method (or the SAE password identifier method without encrypting the password identifier using the AP's public key if over-the-air privacy is not a concern).

If a STA's PDC is a client certificate and if the STA does not need relayed EAP service, a STA can connect to an AP using EAP-TLS v1.3 (or EAP-TLS if over-the-air privacy is not a concern) between the STA and the AP (e.g., Matter Protocol, Device Provisioning Protocol, (DPP)).

According to embodiments, if a STA's PDC is a client certificate, and a STA requires or prefers relayed EAP service, and an AP supports relayed EAP service (e.g., Passpoint, Enterprise), a STA can connect to an authentication server (specified by the STA in case of Passpoint) for mutual authentication. An AP can relay EAP-TLS v1.3 messages between a STA and an authentication server. A STA's identity can remain secret from an AP.

According to embodiments, a STA's PDC can be a triplet of (user id, password, PDC server URL). If a STA requires or prefers relayed EAP service, and if an AP supports such service (e.g., Passpoint-like personal network roaming), a STA can connect to a PDC server specified by the STA for mutual authentication, with an AP relaying the EAP-TTLS or TEAP messages between the STA and the PDC server. A STA's identity can remain secret from an AP.

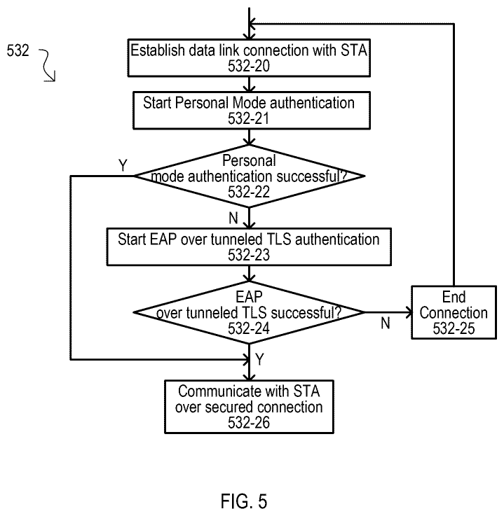

FIG. 6 is a flow diagram of a method 634 according to a further embodiment. A method 634 can include actions, all or a portion of which can be executed by an Authentication Server (Server). A method 634 can include receiving an access request from an AP with a credential 634-0. In some embodiments, a credential can be an AP digital certificate issued by the Server or its related organization. In some embodiments, a Server can also receive an admission set from an AP identifying STAs it can support. If an AP credential is not valid (N from 634-3), the access grant can be aborted 634-1.

If an AP credential is valid (Y from 634-3), a Server can transmit a TTLS-Start message to a STA, that is relayed by an AP in an EAP-Request 643-4. If a corresponding Client-Hello message (relayed by an AP) is not received (N from 634-5), an access grant can be aborted 634-1. If the Client-Hello is received (Y from 634-5), a challenge value (e.g., random number) provided by a STA within a Client-Hello message can be signed with a Server private key 634-6. A Server digital certificate, along with a signed challenge value can be transmitted to a STA (be relayed as a EAP-Request by an AP) 634-7. A tunnel connection can then be established between a STA and Server via an AP 634-8.

An authentication operation can then be executed with a STA via a tunnel connection 634-9. Such an authentication operation can take any suitable form, including but not limited to EAP-TTLS/PAP or EAP-TTLS/MSCHAPv2. If such in-tunnel authentication is not successful (N from 634-10), an access grant can be aborted 634-1.

If in-tunnel authentication is successful (Y from 634-10) and a STA is in the AP admission set (Y from 634-2), an authentication success message with encryption base values can be transmitted to a STA 634-11. Otherwise (N from 634-10 or 634-2), an access grant can be aborted 634-1. Encryption base values can take any suitable form (e.g., PMK or a temporary secret). A tunnel can then be torn down 634-12. In some embodiments, in the event a Server expects relatively frequent communication with an AP, a tunnel can be maintained.

Encryption base values can then be transmitted an AP via a secure AP to S connection 634-13.

In this way, a method can include receiving an Authenticator admission set and credential from an Authenticator, establishing a tunnel connection with a Supplicant through the Authenticator. Through in-tunnel communications, a Supplicant can be authenticated, and if it is on the admission set, provided with encryption base values. Encryption base values may also be provided to the Authenticator through a different private connection.

While embodiments can include systems and methods, embodiments can also include devices corresponding to such systems and methods.

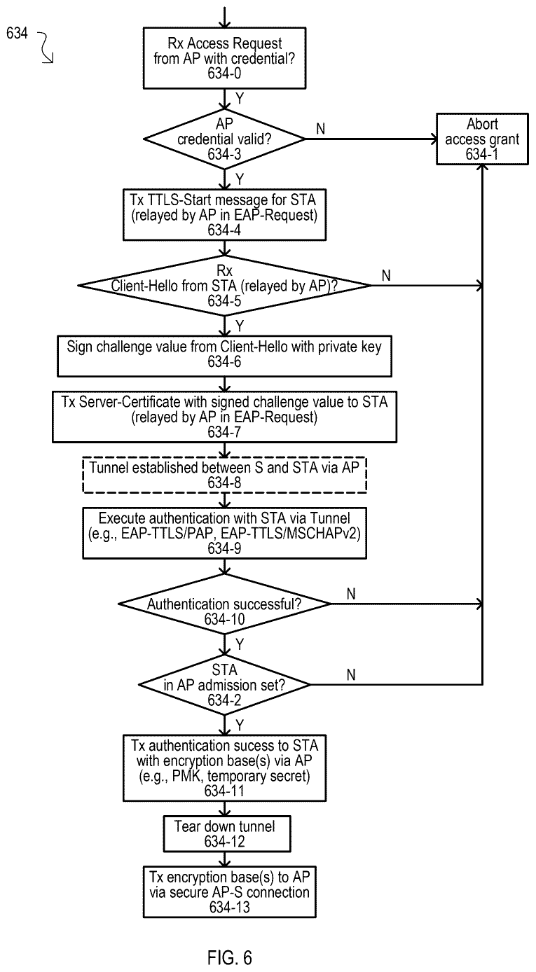

FIG. 7 is a block diagram of a wireless device 704 according an embodiment. A device 704 can be an AP compatible with or more IEEE 802.11 wireless standards. Device 704 can include memory circuits 742, processor circuits 744, wireless circuits 746, and input/output (IO) circuits 748 in communication with one another over a backplane and/or bus 752. Optionally, a device 704 can include bridge interface (IF) circuits 754 and one or more other wireless circuits 756.

Memory circuits 742 can include any suitable memory circuits, including nonvolatile memory with secure storage locations, and optionally, volatile memory. Memory circuits 742 can store data for enabling the various operations of device 704, including supported servers 742-0, a STA admission set 742-1, an AP credential 742-2, and code 742-4. Code 742-4 can include instructions (e.g., firmware) executable by processor section 744 to provide the various processor operations described herein.

Processor circuits 744 can include any suitable circuits for executing operations as described herein, including but not limited to, one or more processors, custom logic, programmable logic, and combinations thereof. Processing circuits can also include a state machine, a sequencer and/or any other suitable circuit, which may be implemented in the form of hardware, firmware, or software, or combinations thereof.

Processing circuits 744 can execute code 742-4 to provide various operations for the device 704. A personal mode operation 744-0 can include an authentication method that does not include in-tunnel communications with a Server (e.g., WPA2-PSK, WPA3-SAE). A capabilities transmission 744-1 can include transmitting a message that indicates that the device 704 can support in-tunnel communications, including but not limited to beacons, probe responses, or identity requests having predetermined IEs. Determining if a Server is supported 744-2 can include checking if Server ID information received from a STA corresponds to a set of supported servers 742-0. For example, if a STA provides a server identification for a server not included in supported servers 742-0, a device 704 can deny an authentication request, or seek an alternative authentication method.

Establishing an AP-S connection 744-3 can include validating a Server with an AP credential 742-2. An EAP failure 744-31 can be generated if AP-S authentication is not successful. Tunnel relay 744-4 operations can include a device 704 acting as a relay between a Supplicant and Server, as described herein and equivalents. In some embodiments, such operations can include a device 704 providing encrypted messages to a STA from a Server as EAP-Requests, and receiving EAP-Responses from a STA that include encrypted messages for a Server.

Wireless circuits 746 can provide wireless communications compatible with one or more IEEE 802.11 wireless standards. Wireless circuits 746 can include MAC layer circuits 746-0, physical layer (PHY) circuits 746-1, and RF circuits 746-2. Such circuits (846-0, −1, −2) can operate on any suitable band, including but not limited to the 2.4 GHz, 5 GHz and/or 6 GHz bands.

IO circuits 748 can provide input signals that can enable control of a device 704, and output data from the device 704 according to any suitable fashion. In some embodiments, IO circuits 748 can include serial communication circuits, including but not limited to interfaces compatible with a serial digital interface (SDI), universal serial bus (USB), universal asynchronous receiver transmitter (UART), I2C, or I2S.

Optional bridge interface circuits 754 can enable communications between wireless circuits 746 and other wireless circuits 765. In some embodiments, such communications can determine which wireless circuits (746 or 756) can control a shared medium (e.g., 2.4 GHz band).

Other wireless circuits 756 can be one or more wireless circuits compatible with a standard different from that of wireless circuits 746, including but not limited to, one or more Bluetooth standards, one or more IEEE 802.15.4 or related standards and/or one or more cellular network standards.

A device 704 can operate in conjunction with an antenna system 760 having one or more antennas compatible with one or more IEEE 802.11 wireless standards, as well as other standards if other wireless section 756 are included. In some embodiments, IO circuits 748, memory circuits 742, processor circuits 744, and wireless circuits 746 can be formed with a same integrated circuit substrate 758.

In this way, a device can include circuits for storing an Authenticator credential for authenticating with a Server, and then operating as a relay for tunnel communications between the Server and a Supplicant.

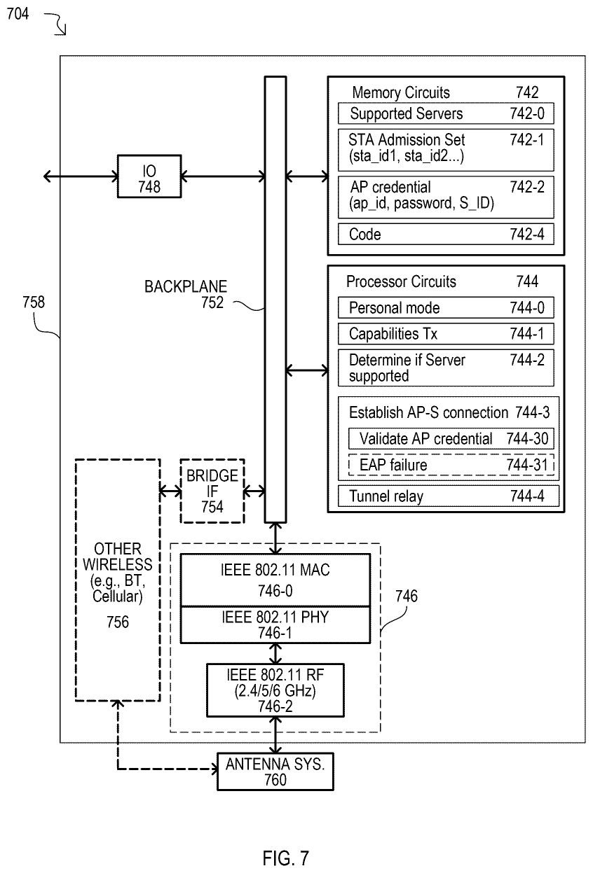

FIG. 8 is a block diagram of a wireless device 802 according to another embodiment. A wireless device 802 can include items like those of FIG. 7, and such like items are referred to by the same reference character, but with the leading digit being an “8” instead of “7”. A device 802 can be a STA compatible with or more IEEE 802.11 wireless standards.

Memory circuits 842 can store one or more PDCs 842-0, a server public key 842-1, and code 842-2. A PDC 842-0 can take the form of any of those described herein, or equivalents, including a triplet 842-00 or a digital certificate 842-01. A PDC 842-0 can be stored in secure memory. Memory circuits 842 can further store one or more server public keys 842-1 and code 842-2 for execution by processor circuits 844.

Processor circuits 844 operations can include connecting at a data link layer 844-0. In some embodiments, such an operation can include connecting to an AP at an uncontrolled port. EAPoL-Start to AP 844-1 can include generating a message to start EAP authentication. A number of EAP responses can be generated with encrypted message to be relayed to a server, including a TTLS-ClientHello message 844-3, which can include a challenge value (e.g., random number) 844-30, a TTLS-Finished message 844-4, and an identity response for a server, that can include a PDC 844-5. Operations can also include authentication with a Server over a STA-AP-S tunnel (i.e., a STA—Server tunnel with AP relaying messages) 844-7, and authentication with an AP over a STA-AP connection (which is different than a tunnel) 844-8.

A device 802 can also include wireless circuits 846, IO circuits 848, substrate 858, and optionally, bridge IF circuits 854 and other wireless circuits 856.

In this way, a device can include circuits for storing a PDC, connecting to an Authenticator, and then authenticating with a Server using the PDC over a tunnel connection where messages are relayed by the Authenticator and the PDC remains hidden from the Authenticator.

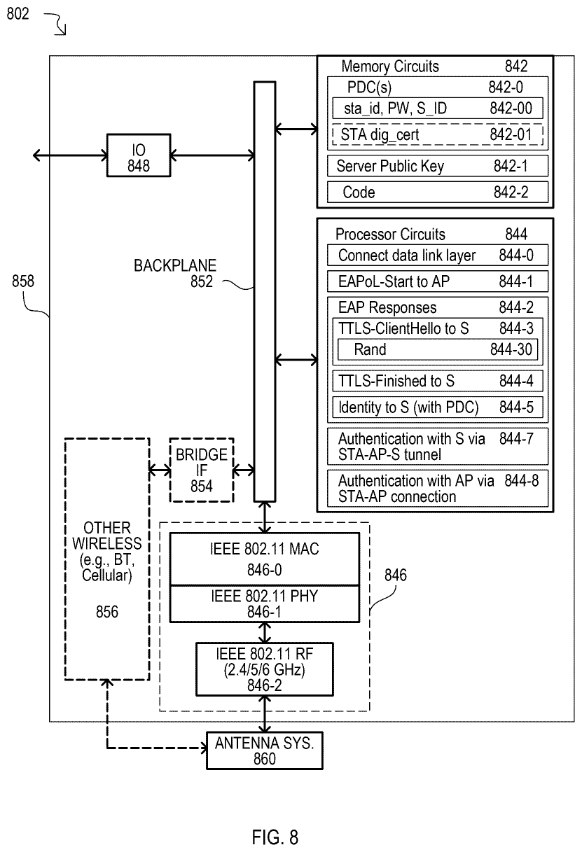

FIG. 9 is a block diagram of a server 906 according to an embodiment. A server 906 can include a processing system 964, memory system 962 and network IF 972. Memory system 962 can store one or more public/private encryption key pairs (Ps/ps) 962-0 and PDCs for one or more STAs 962-1. PDCs can take the form of any of those described herein or equivalents. Memory system 962 can also store one or more AP admission sets 962-2. AP admission sets 962-2 can have been received from APs.

Processing system 964 can include one or more computing systems that can provide various server operations in support of in-tunnel authentication as described herein and equivalents. Such server operations can include, but are not limited to, establishing secure connections with an AP 964-0, tunnel operations 964-1, STA verification 966, in tunnel authentication 968 and transmitting encryption base values to a STA over an AP-S connection 970. Establishing a secure connection with an AP 964-0 can include evaluating an AP certificate. Tunnel operations 964-1 can include establishing a tunnel connection to a STA with an AP-S connection 964-2. In addition, such operations can include TTLS-Start messages to STAs 964-3, TTLS-ServerCertificate messages to STAs 964-4, and TTLS-Identity requests to STAs 964-5. Such messages (964-3, 964-4, 964-5) can be relayed as EAP requests. Such operations can also include tearing down a tunnel 964-6 once a STA has be authenticated or such authentication fails.

Operations can also include in tunnel authentication 968. Such authentication can take any suitable form (e.g., PAP, MSCAPv2). In addition, encryption base values can be generated using PDCs 968-0, and such values can be transmitted to a STA via a tunnel 968-1. Operations can also include transmitting encryption base values to a STA via an AP-S connection 970.

A network IF 972 can enable communications between server 906 and APs. In some embodiments, a network IF 906 can be connected to the Internet, and APs can contact server using S_ID values.

In this way, a Server can include circuits that enable it to establish a Secure connection with an Authenticator, then establish a tunnel connection with a Supplicant via the Authenticator. Through in-tunnel communications, a Supplicant can be authenticated to a Server with its PDC. A Server can then provide encryption base values generated with the PDC to enable mutual authentication between the Supplicant and Authenticator. A PDC remains secret from the Authenticator.

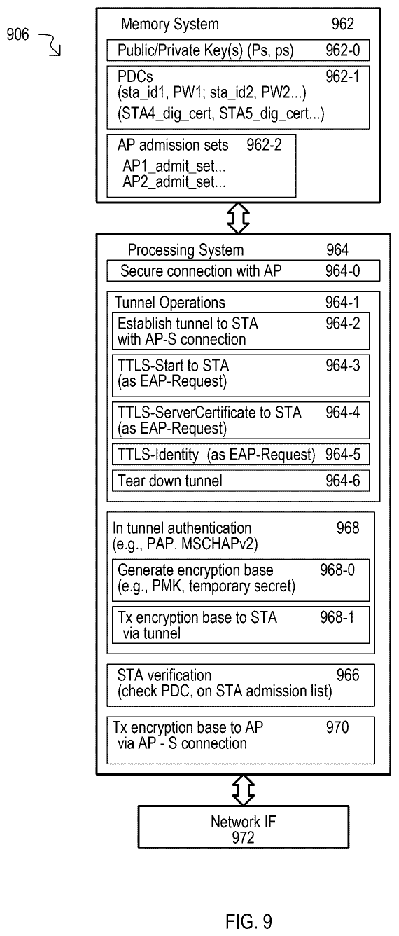

While embodiments can include devices with various interconnected components, embodiments can also include unitary devices capable of executing in-tunnel authentication operation that preserve a Supplicant's privacy as described herein and equivalents. In some embodiments, such unitary devices can be advantageously compact single integrated circuits (IC). FIG. 10 shows a packaged IC device 1002/1004 that can execute communications as a Supplicant or Authenticator according to embodiments shown herein. In some embodiments, a device 1002/1004 can include a substrate 758, 858, as described herein or an equivalent. While FIG. 10 shows a particular package, alternate embodiments can include any other suitable integrated circuit packaging type, as well as direct bonding of a device chip onto a circuit board or substrate.

In this way, a Supplicant or Authenticator, that can enable in-tunnel authentication with a Server while preserving Authenticator privacy, can take the form of an integrated circuit device.

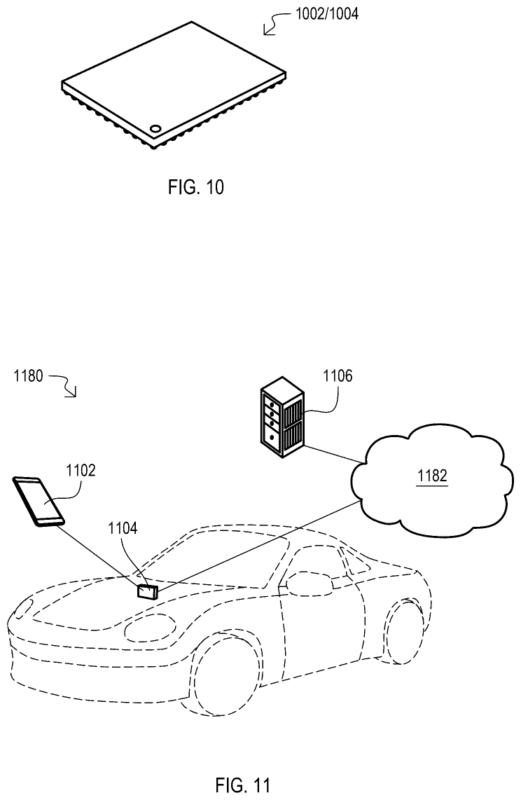

While embodiments can enjoy wide application in various wireless systems, it may be advantageous and otherwise beneficial to employ the privacy capabilities, as described herein, to vehicle systems. FIG. 11 shows a motor vehicle system 1180 according to an embodiment. A motor vehicle system 1180 can include one or more vehicle subsystems (e.g., in-vehicle infotainment system) that can operate as an Authenticator 1104. A Supplicant 1102 (e.g., smartphone), can authenticate itself with the vehicle Authenticator 1104 while maintaining privacy (i.e., its identity is kept secret from the vehicle system). Such authentication can take place using a tunnel connection with a Server 1106, with Authenticator 1104 acting as a relay. An Authenticator 1104 may connect to a Server 1106 over one or more networks 1182, including but not limited to, a cellular network and/or the internet.

In this way, a vehicle can include a wireless system that can authenticate with Supplicant devices while maintaining their privacy.

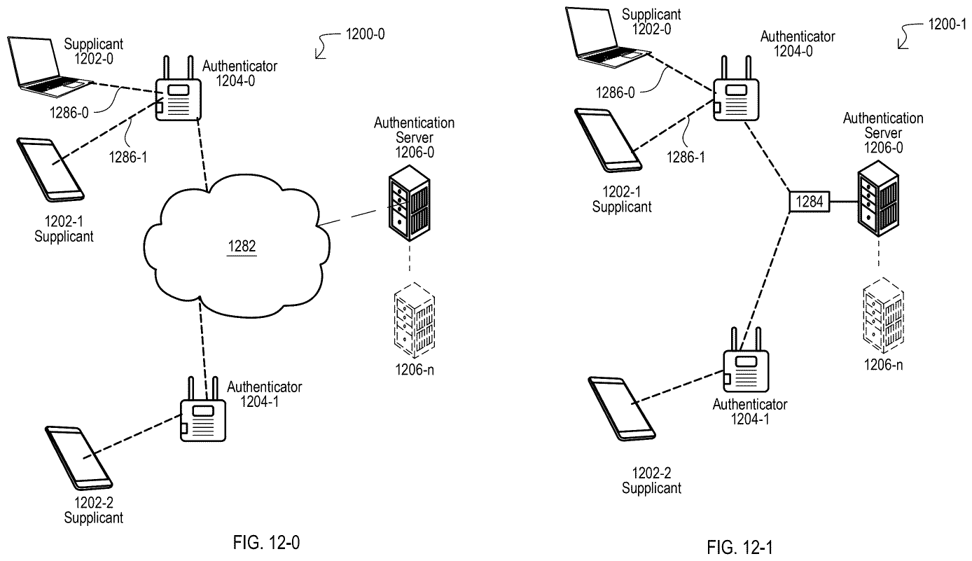

FIG. 12-0 is a diagram showing a system 1200-0 according to another embodiment. A system 1200-0 can include one or more Supplicants (three shown as 1202-0, 1202-1, 1202-2), one or more Authenticators (two shown as 1204-0, 1204-1), a network (e.g., Internet) 1282, and one or more Servers 1206-0 to 1206-n. In some embodiments, Servers (1206-0 to 1206-n) can be essentially always accessible on the Internet. A service provider operating the Servers (1206-0 to 1206-n) can issue PDCs to Supplicants (1202-0, 1202-1, 1202-2) which can authenticate using in-tunnel authentication as described herein and equivalents, to preserve user privacy from eavesdropping over the air and from Authenticators (1204-0, 1204-1).

In some embodiments, a system 1200-0 can have optional PDC privacy for certain Supplicants (e.g., visitors) while other Supplicants can use a Personal mode (i.e., expose user identification). Thus, one Supplicant 1202-0 may authenticate in a personal mode 1286-0 with communications with authenticator 1204-0, while another Supplicant 1202-1 can use in-tunnel authentication 1286-1 with messages relayed to a server (1206-0 to 1206-n) via Authenticator 1204-0.

FIG. 12-1 is a diagram showing a system 1200-1 according to another embodiment. A system 1200-1 can include items like those of FIG. 12-0, and such like items are referred to by the same reference characters. A system 1200-1 can differ from that of FIG. 12-0, in that Authenticators 1206-0 to 1206-n can be part of an intranet 1284. As in the case of FIG. 12-0, in some embodiments, some Supplicants may authenticate without user privacy 1286-0 while others may use in-tunnel authentication with Server(s) (1206-0 to 1206-n) 1286-1.

In this way, systems can provide user (e.g., PDC) protection from eavesdropping, as well as from an Authenticator device for essentially always present authentication (e.g., Server clusters over the internet) as well as for Authenticators that part of an intranet.

Embodiments can include methods, devices and systems where, by operation of a supplicant device, at least an S_ID can be transmitted to an authenticator device over a wireless supplicant—authenticator connection. A tunnel connection can be established with an authentication server that includes messages relayed between the authentication server and the supplicant device by the authenticator device. An authentication operation can be executed with the authentication server over the tunnel connection using a PDC that remains encrypted with respect to the authenticator device. At least one encryption base value can be received from the authentication server via the tunnel connection. Authentication operation can be executed with the authenticator device using the at least one encryption base value over the supplicant—authenticator connection. A PDC can be essentially unique to the supplicant device.

Embodiments can include methods, devices and systems having memory circuits configured to store at least one PDC that is essentially unique to the device, and an S_ID that identifies an authentication server. Processor circuits can be configured to establish a wireless tunnel connection with the authentication server having messages relayed by at least one an authenticator device, execute an authentication operation with the authentication server over the tunnel connection using at least a portion of the PDC, and execute an authentication operation with the authenticator device using at least one encryption base value received from the authentication server over the tunnel connection. Wireless circuits can be configured to receive and transmit messages according to at least one wireless standard. A tunnel connection can include messages with encrypted data for which the authenticator device does not have a decryption key.

Embodiments can include methods, devices and systems having a supplicant device configured to store at least one PDC that is essentially unique to the supplicant device and an S_ID that identifies an authentication server, establish a wireless tunnel connection with the authentication server having messages relayed by at least one an authenticator device, execute an authentication operation with the authentication server over the tunnel connection using at least a portion of the PDC that is encrypted with respect to the authenticator device, and execute an authentication operation with the authenticator device using at least one encryption base value received from the authentication server over the tunnel connection. An antenna system can also be included.

Methods, devices and systems according to embodiments can include a wireless connection with the authenticator device being compatible with at least one IEEE 802.11 wireless standard.

Methods, devices and systems according to embodiments can include a PDC selected from the group consisting of: a set of values that includes a supplicant identification value, a password, and the S_ID, and a supplicant digital certificate signed by the authentication server.

Methods, devices and systems according to embodiments can include establishing a tunnel connection by validating an authentication server with a server digital certificate issued by a certificate authority.

Methods, devices and systems according to embodiments can include an authentication operation executed with the authentication server over the tunnel connection that is compatible with a standard selected from the group consisting of: EAP-TTLS, TEAP, and EAP-TLS v1.3.

Methods, devices and systems according to embodiments can include a PDC having includes a password. An authentication operation executed with an authentication server can include transmitting a supplicant identification value, receiving a challenge value from the authentication server, executing a predetermined operation on the challenge value using the password, and transmitting a resulting value to the authentication server via the tunnel connection.

Methods, devices and systems according to embodiments can include at least one encryption base value that is selected from the group consisting of: a pairwise master key and a temporary secret.

Methods, devices and systems according to embodiments can include executing an authentication operation with an authenticator device that includes a four-way handshake with the authenticator device over a wireless connection with the authenticator device.

Methods, devices and systems according to embodiments can include, by operation of an authenticator device, establishing a secure connection with the authentication server using at least the S_ID received from the supplicant device, receiving the at least one encryption base value from the authentication server, and executing the authentication operation with the supplicant device using the at least one encryption base value.

Methods, devices and systems according to embodiments can include relaying messages for the tunnel connection by transmitting EAP requests to a supplicant device from the authentication server, and receiving EAP responses from a supplicant device.

Methods, devices and systems according to embodiments can include, by operation of an authenticator device, transmitting an admission set that includes identifying information for a plurality of supplicant devices. By operation of the authentication server, an authentication operation over the tunnel connection can be terminated if data within the PDC received from the supplicant device is not included on the admission set.

Methods, devices and systems according to embodiments can include at least one wireless standard includes a IEEE 802.11 wireless standard; and an authentication operation executed with an authentication server is compatible with a standard selected from the group consisting of: EAP-TTLS, TEAP, and EAP-TLS v1.3.

Methods, devices and systems according to embodiments can include at least one wireless standard includes a IEEE 802.11 wireless standard; and establishing a tunnel connection includes an authentication protocol selected from the group consisting of: PAP and a CHAP type protocol.

Methods, devices and systems according to embodiments can include an authenticator device is configured to establish a secure access-server connection using at least the S_ID, receive the at least one encryption base value over the access-server connection, and execute an authentication operation with the supplicant device using the at least one encryption base value.

Methods, devices and systems according to embodiments can include an authenticator device configured to, in response to receiving an S_ID, determining if the authenticator device supports communications with an authentication server corresponding to the S_ID, and transmit an admission set to the authentication server that indicates supplicant devices for which the authenticator device will allow access.

Methods, devices and systems according to embodiments can include an authentication server configured to establish the tunnel connection with supplicant device, transmit the at least one encryption base value to the supplicant device over the tunnel connection, and transmit the at least one encryption base value to the authenticator device over a secure connection with the authenticator device.

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of exemplary embodiments of the invention, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claims require more features than are expressly recited in each claim. Rather, inventive aspects lie in less than all features of a single foregoing disclosed embodiment. Thus, the claims following the detailed description are hereby expressly incorporated into this detailed description, with each claim standing on its own as a separate embodiment of this invention.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

1. A method, comprising:
by operation of a supplicant device,
transmitting at least authentication server identification data (S_ID) to an authenticator device over a wireless supplicant - authenticator connection,
establishing a tunnel connection with an authentication server that includes messages relayed between the authentication server and the supplicant device by the authenticator device,
executing an authentication operation with the authentication server over the tunnel connection using a per-device credential (PDC) that remains encrypted with respect to the authenticator device,
receiving at least one encryption base value from the authentication server via the tunnel connection, and
executing an authentication operation with the authenticator device using the at least one encryption base value over the supplicant - authenticator connection; wherein
the PDC is essentially unique to the supplicant device.

2. The method of claim 1, wherein the wireless connection with the authenticator device is compatible with at least one IEEE 802.11 wireless standard.

3. The method of claim 1, wherein:
the PDC is selected from the group consisting of:
a set of values that includes a supplicant identification value, a password, and the S_ID, and
a supplicant digital certificate signed by the authentication server.

4. The method of claim 1, wherein establishing the tunnel connection includes validating the authentication server with a server digital certificate issued by a certificate authority.

5. The method of claim 1, wherein the authentication operation executed with the authentication server over the tunnel connection is compatible with a standard selected from the group consisting of: Extensible Authentication Protocol Tunneled Transport Layer Security (EAP-TTLS), Tunneled EAP (TEAP), and EAP-TLS v1.3.

6. The method of claim 1, wherein:
the PDC includes a password; and
executing the authentication operation with the authentication server includes
transmitting a supplicant identification value,
receiving a challenge value from the authentication server,
executing a predetermined operation on the challenge value using the password, and
transmitting a resulting value to the authentication server via the tunnel connection.

7. The method of claim 1, wherein the at least one encryption base value is selected from the group consisting of: a pairwise master key and a temporary secret.

8. The method of claim 1, wherein executing the authentication operation with the authenticator device includes a four-way handshake with the authenticator device over the wireless connection with the authenticator device using at least one encryption base value received from the authentication server over the tunnel connection.

9. The method of claim 1, further including:
by operation of the authenticator device
establishing a secure connection with the authentication server using at least the S_ID received from the supplicant device,
receiving the at least one encryption base value from the authentication server, and
executing the authentication operation with the supplicant device using the at least one encryption base value.

10. The method of claim 9, wherein:
relaying messages for the tunnel connection includes
transmitting Extensible Authentication Protocol (EAP) requests to the supplicant device from the authentication server, and
receiving EAP responses from the supplicant device.

11. The method of claim 1, further including:
by operation of the authenticator device, transmitting an admission set that includes identifying information for a plurality of supplicant devices; and
by operation of the authentication server, terminating the authentication operation over the tunnel connection if data within the PDC received from the supplicant device is not included on the admission set.

12. A device, comprising:
memory circuits configured to store at least one per-device credential (PDC) that is essentially unique to the device, and server identification data (S_ID) that identifies an authentication server;
processor circuits configured to
establish a wireless tunnel connection with the authentication server having messages relayed by at least one an authenticator device,
execute an authentication operation with the authentication server over the tunnel connection using at least a portion of the PDC, and
execute an authentication operation with the authenticator device using at least one encryption base value received from the authentication server over the tunnel connection; and
wireless circuits configured to receive and transmit messages according to at least one wireless standard; wherein
the tunnel connection includes messages with encrypted data for which the authenticator device does not have a decryption key.

13. The device of claim 12, wherein:
the at least one wireless standard includes a IEEE 802.11 wireless standard; and
the authentication operation executed with the authentication server is compatible with a standard selected from the group consisting of:
Extensible Authentication Protocol Tunneled Transport Layer Security (EAP-TTLS), tunneled EAP (TEAP), and EAP-TLS v1.3.

14. The device of claim 12, wherein:
the at least one wireless standard includes a IEEE 802.11 wireless standard; and
establishing the tunnel connection includes an authentication protocol selected from the group consisting of: a Password Authentication Protocol (PAP) and a Challenge-Handshake Authentication Protocol type (CHAP type).

15. A system, comprising:
a supplicant device configured to
store at least one per-device credential (PDC) that is essentially unique to the supplicant device and server identification data (S_ID) that identifies an authentication server,
establish a wireless tunnel connection with the authentication server having messages relayed by at least one an authenticator device,
execute an authentication operation with the authentication server over the tunnel connection using at least a portion of the PDC that is encrypted with respect to the authenticator device, and
execute an authentication operation with the authenticator device using at least one encryption base value received from the authentication server over the tunnel connection; and
an antenna system.

16. The system of claim 15, wherein the PDC is selected from the group consisting of: a set of values that includes a supplicant identification value, a password, and the S_ID, and a supplicant digital certificate issued by an entity controlling the authentication server.

17. The system of claim 15, wherein the at least one encryption base is selected from the group consisting of a pairwise master key and a temporary secret.

18. The system of claim 15, further including:
the authenticator device is configured to
establish a secure authenticator device-authentication server (access-server) connection using at least the S_ID,
receive the at least one encryption base value over the access-server connection, and
execute an authentication operation with the supplicant device using the at least one encryption base value.

19. The system of claim 18, wherein:
the authenticator device is further configured to
in response to receiving the S_ID, determining if the authenticator device supports communications with an authentication server corresponding to the S_ID, and
transmit an admission set to the authentication server that indicates supplicant devices for which the authenticator device will allow access.

20. The system of claim 15, wherein:
the authentication server is configured to
establish the tunnel connection with supplicant device,
transmit the at least one encryption base value to the supplicant device over the tunnel connection, and
transmit the at least one encryption base value to the authenticator device over a secure connection with the authenticator device.
